(19) United States
(12) Patent Application Publication
(10) Pub. No.: US 2002/0064042 A1
(43) Pub. Date: May 30, 2002

(54) Concert candle

(76) Inventor: Gina Lynn Leslie, Van Nuys, CA (US)

Correspondence Address: CHARLES R. SUTTON, 14507 SYLVAN ST., STE. 208, VAN NUYS, CA, 91411, US

(21) Appl. No.: 09/995,507

(22) Filed: Nov. 27, 2001

Related U.S. Application Data
(60) Provisional application No. 60/253,290, filed on Nov. 27, 2000.

(51) Int. Cl. F21L 4/00

(52) U.S. Cl. 362/191; 362/161; 362/200

(57) ABSTRACT

A small light which is made to resemble a flame source and which is meant to be carried into concerts and the like for the purpose of display at appropriate times so that the concertgoer can express his or her approval. Since the light is not a flame source, the safety of all the concertgoers is greatly improved and yet the aesthetics of the concert experience are preserved.

### CROSS-REFERENCES TO RELATED APPLICATIONS.

This application incorporates provisional application No. 60/253290 by this reference. Provisional application No. 60/253290 was filed on Nov. 27, 2000. Applicant claims the benefit of the Nov. 27, 2000 filing date pursuant to 35 U.S.C. 119.

### STATEMENT AS TO RIGHTS TO INVENTIONS MADE UNDER FEDERALLY-SPONSORED RESEARCH AND DEVELOPMENT

This invention was not made under federally sponsored research and development. The inventor retains all rights.

### BACKGROUND OF THE INVENTION

At concerts it has become customary to hold a light source up during a particularly popular love song or anthem to show one's deep appreciation for the song. Sometimes at the end of the musician's set the same light source is used to to signify approval and signal the audience's desire that the musician should come out and perform an encore. Often this has been done with an open flame such as by using a cigarette lighter. Open flames in densely packed public spaces present a substantial fire hazard.

1. Field of the Invention

The field of this invention is that of entertainment related novelty or safety equipment. This is an item which could be imprinted with advertising and given to concertgoers as a free promotion or it could be sold, with or without imprinting, at stores catering to a concert oriented clientele, sold as souvenirs at concert venues, or even just sold out in the parking lot. It is safety equipment nevertheless, since for every person using this light source instead of a match or cigarette lighter, there is that much less likelihood of a tragedy occurring such as a fire within the concert house.

2. Description of Related Art Including Information Disclosed Under 37 CFR Sections 1.97 and 1.98

In the prior art, it is known to provide an electrical light source which simulates a flame. The common example is that of a chandelier which appears to have candles in it but from which electrical light actually emanates. Usually this is accomplished by having the incandescent filament be shaped like a flame and be housed within a bulb which is also shaped like a flame. The prior art also contains small hand held light emitting devices such as pen lights or “mag lights.” These are not made to resemble a hand held flame such as a candle or cigarette lighter.

### SUMMARY OF THE INVENTION

This invention fills a void by providing a small hand held light source which simulates a hand held flame such as a candle or cigarette lighter. Concert houses could ensure that the clientele have these rather than cigarette lighter or the like. In this way, the concertgoers can have the pleasure of applauding a performance with a small light source while at the same time the concert hall has the peace of mind to know that thousands of people are not packed into a room full of open flames. The invention could come in designs which mimic cigarette lighters or which mimic candles. The light could activate when the flame shaped top (1) is screwed on (like the way a mag-light is activated) or the light could be activated by a switch (2). The switch could be made to be part of the deceptive design, such as by having it appear to be the gas dispensing lever of a cigarette lighter.

### BRIEF DESCRIPTION OF THE DRAWINGS

FIG. 1 shows an embodiment of the invention designed to resemble a candle.

FIG. 2 is an exploded diagram of the simulated candle of FIG. 1.

FIG. 3 shows an embodiment of the invention designed to resemble a cigarette lighter.

FIG. 4 shows a cutaway view of the invention unscrewed so the circuit is not complete.

FIG. 5 shows a cutaway view of the invention screwed together so the circuit is complete.

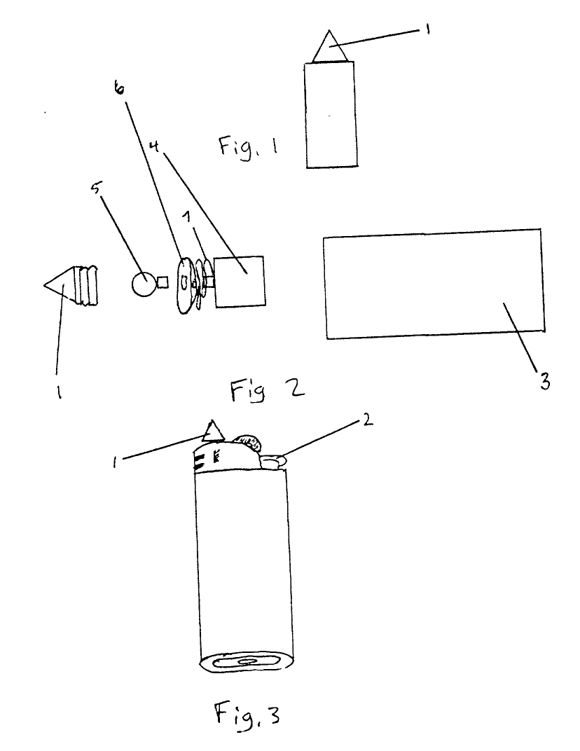

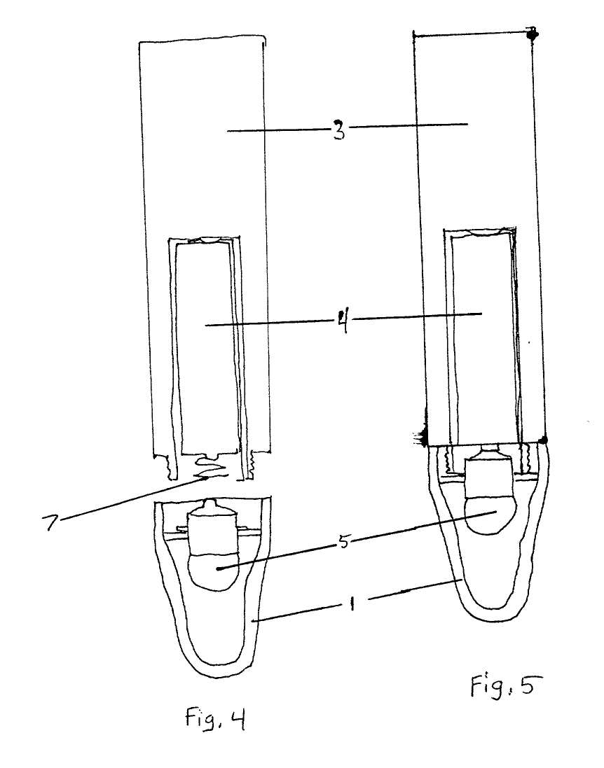

### DESCRIPTION OF THE PREFERRED EMBODIMENT

In the preferred embodiment this invention takes the form of a small hand held light made to resemble a candle. It has a flame shaped top (1) which is transparent or translucent and may or may not be colored. The flame shaped top screws onto the body (3) and thus activates the light. The activation is due to the fact that when the top is screwed on, it creates an electric circuit that includes, in series, a battery (4), one or more bulbs (5) and conductive material (6). A spring (7) on the inside holds the battery apart from the conductive material so that there is no circuit unless the top is screwed firmly on. The body is opaque and may be manufactured in a variety of colors. It may, in fact, be manufactured with advertising or logos on the outside to enhance the marketability of the product. Ideally, the battery would be small and inexpensive since the utility of the invention would be adversely affected if the cost to manufacture it is too high. The bulb or bulbs lighted at any given time may be lighted in a pattern to simulate the movement of a flame.

In another embodiment these elements could be combined in such a way that they resemble a cigarette lighter. The body could be manufactured so that it looks like a cigarette lighter, and what appears to be the lever to release butane gas is actually the switch (2) which activates the light. In this embodiment, the screw on top could create a circuit as in the other embodiment to start the light. If the switch is used, though, it is simply added to the series circuit with the bulb, battery, and conductive material.

I claim:

1. A safety light comprising:
a battery having a first pole and a second pole;
a light source having a first end and a second end;
first conductive means connecting said first pole of said battery to said first end of said light source;
second conductive means connecting said second pole of said battery to a switch means;
third conductive means connecting said switch to said second end of said light source;
said battery, said first conductive means, said second conductive means, and said third conductive means all being contained within a body shaped to resemble a hand held flame source;
said light source being on the exterior of said body and resembling a flame;
said switch means is disposed outside said body so that the user can actuate said light source.

2. The safety light of claim 1 wherein said light source is at least one light emitting diode.

3. The safety light of claim 1 further comprising a concave reflector; said light source is situated at the focal point of said concave reflector whereby light is reflected in a certain direction.

4. The safety light of claim 1 wherein said body has an outside surface, said outside surface bearing indicia.

5. The safety light of claim 1 further comprising:
said light source is a plurality of discrete light sources; said switch means can actuate said plurality of discrete light sources individually; said switch actuates said plurality of light sources randomly to simulate a flame.

6. The safety light of claim 1 wherein said light source is an incandescent light bulb.

7. The safety light of claim 6 wherein said incandescent light bulb is shaped to resemble a flame.

8. The safety light of claim 6 further comprising:
a spring biasing said second pole away from said second end;
said switch means comprises first threads on said body;
said third conductive means comprises a top having second threads capable of engaging said first threads so as to urge said second pole against said second end closing the circuit.
